(19) United States
(12) Patent Application Publication
(10) Pub. No.: US 2024/0323257 A1
(43) Pub. Date: Sep. 26, 2024

(54) SYSTEM AND METHOD FOR TAG-GATEWAY COMMUNICATIONS

(71) Applicant: Wiliot, Ltd., Caesarea (IL)

(72) Inventors: Eli SORIN, Mitzpe Aviv (IL); Dotan ZIV, Tel Aviv (IL); Matan BEN-MOSHE, Hoshaya (IL); Ori RAFALIN, Herzliya (IL); Dima BERSHADSKIY, Kiev (UA)

(73) Assignee: Wiliot, Ltd., Caesarea (IL)

(21) Appl. No.: 18/598,113

(22) Filed: Mar. 7, 2024

Related U.S. Application Data
(60) Provisional application No. 63/491,166, filed on Mar. 20, 2023.

(51) Int. Cl. H04L 67/12; H04L 41/0803; H04W 40/02

(52) U.S. Cl. CPC H04L 67/12; H04L 41/0803; H04W 40/02

(57) ABSTRACT

A method for updating a configuration of a bridge in a network comprising at least the bridge, a gateway, and a server, the updating being performed using at least a portion of a protocol for wireless communication between the gateway and the bridge that does not support ACK/NACK messages, comprising: receiving by the server an indication of a current state of the bridge; when that is not a desired state: setting, in the server, the current state of the bridge to pending for the desired state; transmitting a configure request to update the bridge to the desired state; and when, within a predetermined period of time of transmitting the configure request, a completion message is received by the server from the bridge in response to updating the bridge configuration, setting the current state of the bridge to the desired state in the server.

### CROSS REFERENCE TO RELATED APPLICATIONS

This application claims the benefit of U.S. Provisional Application No. 63/491,166 filed on Mar. 20, 2023, the contents of which are incorporated herein by reference.

### TECHNICAL FIELD

The present disclosure relates generally to wireless Internet of Things (IOT) devices, and more particularly to the network of IoT tags.

### BACKGROUND

The Internet of Things (IOT) is the inter-networking of physical devices, vehicles, buildings, and other items embedded with electronics, software, sensors, actuators, and network connectivity that enable these objects to collect and exchange data. IoT is expected to offer advanced connectivity of devices, systems, and services that goes beyond machine-to-machine (M2M) communications and covers a variety of protocols, domains, and applications.

IoT can be encapsulated in a wide variety of devices, such as heart monitoring implants, biochip transponders on farm animals, automobiles, with built-in sensors, automation of lighting, heating, ventilation, air conditioning (HVAC) systems, and appliances such as washer/dryers, robotic vacuums, air purifiers, ovens or refrigerator/freezers that use wireless fidelity (Wi-Fi) for remote monitoring. Typically, IoT devices encapsulate wireless sensors or a network of such sensors.

Most IoT devices are wireless devices that collect data and transmit such data to a central controller. There are a few requirements to be met to allow widespread deployment of IoT devices. Such requirements include reliable communications links, low energy consumption, and low maintenance costs.

To this aim, an IoT device and wireless sensors are designed to support low power communication protocols, such as Bluetooth low energy (BLE), long range (LoRa) radio frequency, and the like. To achieve low power consumption, at the physical layer, a wireless BLE-compliant device can be configured as a transmitter or a receiver. That is, a device can implement only a transmitter or a receiver. At the Link Layer, devices are divided into advertisers, scanners, slaves, and masters. An advertiser is a device that transmits packets; a scanner is a device that receives the advertiser's packets. A slave is connected with a master. Typically, advertisers and slaves have the lowest possible memory and processing burden, thus demonstrating low power (energy) consumption.

That is, all electronic devices require a power source to operate. Even devices, such as low-power IoT devices, that are designed to support low power communication protocols operate using a battery, (e.g., a coin battery). As an alternative to batteries, power supply may be harvested from other sources, such as light, mechanical movement, and electromagnetic radiation, (e.g., existing radio frequency transmissions). The harvested power is stored in a rechargeable battery.

The limitations of the systems or network providing a large number of IoT devices, and specifically battery-less devices are communication and power. Currently, there are no reliable methods to ensure constant power charging of battery-less devices and to ensure error-free communication with network devices outside the network of the IoT devices.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for updating a configuration of a bridge in a network comprising at least the bridge, a gateway, and a server, the server being communicatively coupled to the gateway which is in turn wirelessly communicatively coupled to the bridge, the bridge being for communicating with and supplying energy for operation to Internet of Things (IOT) wireless tags, the updating being performed using at least a portion of a protocol for wireless communication between the gateway and the bridge that does not support acknowledgement (ACK) messages or no acknowledgement (NACK) messages. The method comprises: receiving by the server an indication of a current state of the bridge; when the current state of the bridge is not a desired state: setting, in the server, the current state of the bridge to pending for the desired state; transmitting, by the server toward the bridge, a configure request to update the bridge to the desired state; and when, within a predetermined period of time of transmitting the configure request, a completion message is received by the server from the bridge in response to updating the bridge configuration in response to the configure request, setting the current state of the bridge to the desired state in the server.

Certain embodiments disclosed herein include a method for updating a configuration of a bridge in a network comprising at least the bridge, a gateway, and a server, the server being communicatively coupled to the gateway which is in turn wirelessly communicatively coupled to the bridge, the bridge being for communicating with and supplying energy for operation to Internet of Things (IOT) wireless tags, the updating being performed using at least a portion of a protocol for wireless communication between the gateway and the bridge that does not support acknowledgement (ACK) messages or no acknowledgement (NACK) messages. The method comprises: transmitting by the bridge an indication of a current state of the bridge toward the server; receiving, by the bridge, a configure request to update the bridge to a desired state; and transmitting, by the bridge, a completion message toward the server in response to the bridge successfully completing the updating of the bridges configuration per the configure request.

### BRIEF DESCRIPTION OF THE DRAWINGS

In the drawing:

FIG. 1 shows an illustrative diagram of the IoT network arranged and operable according to the disclosed embodiments.

FIG. 2 shows an illustrative diagram of an asymmetric topology of the IoT network according to an embodiment.

FIG. 3 shows an illustrative structure of a BLE advertising packet transmitted by a bridge according to an embodiment.

FIG. 4 shows an illustrative flow diagram illustrating the bridge configuration flow according to an embodiment.

FIG. 5 shows an illustrative diagram of a gateway constructed according to an embodiment.

FIG. 6 shows an illustrative block diagram of a bridge constructed according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The embodiments disclosed herein include a network for the operation of IoT devices or tags (hereinafter “IoT tags”). The disclosed embodiments further include a bridge for communicating and energizing (or powering) IoT tags. The IoT network further includes a gateway configured to communicate with servers deployed in a cloud computing platform, thereby acting as edge devices. The gateway, bridges, and IoT tags are part of the topology of the disclosed network of IoT tags (hereinafter the “IoT network”).

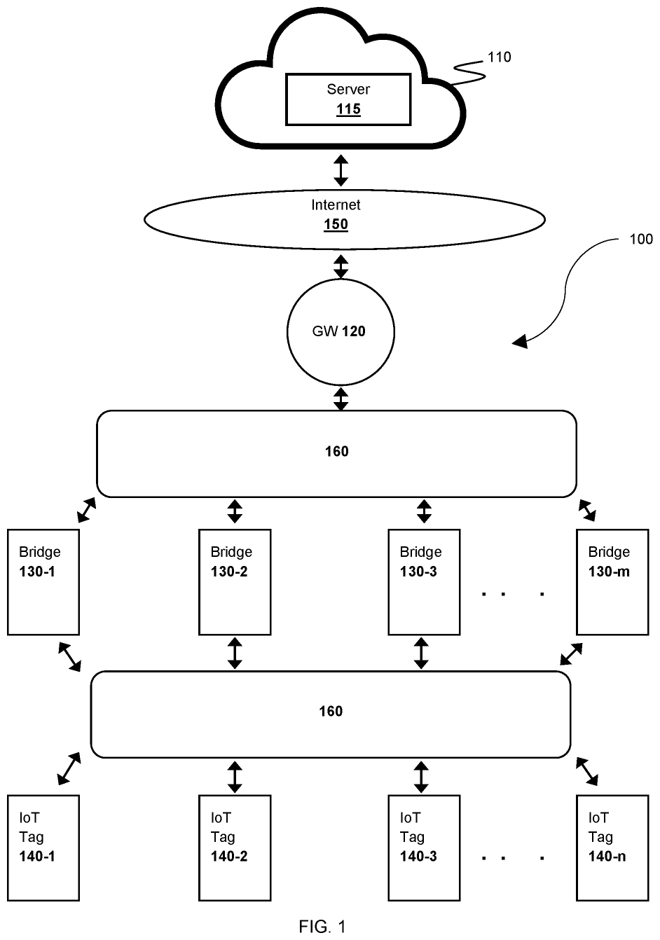

FIG. 1 is an illustrative diagram of the IoT network 100 arranged and operable according to the disclosed embodiments. The IoT network 100 enables the communication between a cloud computing platform 110 and a plurality of IoT tags 140 through at least one gateway 120 and bridges 130-1 through 130-m (collectively referred to as a bridge 130 or bridges 130-m, where m is an integer equal or greater than 1). The cloud computing platform 110 hosts at least one server 115 configured to process signals transmitted by the IoT tags 140 and relayed to the server 115 by the gateway 120. The connection between the cloud computing platform 110 and the gateway 120 is over, for example, the Internet 150.

The cloud computing platform 110 provides computing resources, storage, and applications over the Internet on a subscription or pay-as-you-go basis. The cloud computing platform 110 may include a public cloud, a private cloud, a hybrid cloud, or a combination thereof. A non-limiting example for the cloud computing platform 110 may include Amazon web services (AWS). The server 115 may be implemented as a physical machine, a virtual machine, or a combination thereof. It should be noted that only one server 115 is shown merely for illustration purposes.

The IoT tags 140-1 through 140-n (collectively referred to as an IoT tag 140 or IoT tags 140) may be attached to items (such as merchandise, containers, boxes, etc.). All IoT tags 140 are located in close proximity to each other (e.g., a warehouse, a store, etc.). An IoT tag 140 may be adhesive or printed on an item. In an embodiment, an IoT tag 140 is a battery-less tag energized by over-the-air signals. To this end, an IoT tag 140 includes a harvester to harvest energy from over-the-air signals.

The IoT tags 140 only transmit signals carrying sensing data. As such, the tags 140 do not receive any data or control signals from other devices, including other tags, bridges 130, or gateway 120. The signals transmitted by an IoT tag 140 may include signals related to particular radio frequency (RF) activity sensed by an IoT tag 140 and some identification information, such as a tag ID. The signals related to particular RF activity may include, for example, a frequency calibration word.

In an embodiment, an IoT tag 140 is configured to transmit data packets, including a tag ID and a frequency calibration word. Such packets may be transmitted when an IoT tag harvests enough energy to execute a transmit operation. The frequency calibration word may be changed based on various changes in the surrounding of an IoT tag 140. For example, any change in humidity, temperature, location, positions, interferences, and so on, can modify the frequency calibration word transmitted by the tag. Changes to the temperature in the ambient environment or changes in the location of the IoT tag 140 will remove the tag from synchronization, thereby would change the value of the frequency word.

The server 115 may be configured to execute a process to analyze frequency calibration words transmitted by the IoT tags for various applications. Examples of such applications may include determining the freshness of food, locations of items attached to the tags 140, humidity in the vicinity of the IoT tags 140, and so on. The tag ID is a unique identifier (ID) of the tag created during the production of an IoT tag 140.

The IoT tags 140 communicate with the bridges 130 using a low-energy communication protocol over a short-range local area network 160. As noted above, such communication is limited to the bridges 130 receiving signals from the IoT tags 140. The bridges 130 also communicate with the gateway 120 using a low-energy communication protocol over a short-range local area network 160. An example for such protocol includes a BLE, which are short-wavelength radio waves operating at a range of about 2.40 to 2.485 GHZ, and commonly used among portable mobile devices. Another example of a low-energy communication protocol includes a long range (LoRa) radio frequency protocol. In a preferred embodiment, discussed in detail below, control messages between bridges 130 and gateway 120 are carried over BLE advertising packages. Such messages may include control and calibration data.

The gateway 120 is structured and configured according to the disclosed embodiments and acts as an edge device for the cloud computing platform 110. To this end, the gateway 120 is configured to communicate with the server 115 installed in the cloud computing platform 110. Here, the gateway 120 can receive and send data to the server 115, typically over the Internet. The gateway 120 is configured to serve the bridges 130 by relaying data packets from the IoT tags 140 to the server 115 in the cloud computing platform 110. All data sent and received by the gateway 120 over the Internet 150 and network 160 are secured, thereby providing a secure connection between the IoT tags 140 and server 115.

In an embodiment, the gateway 120 is configured to register with the server 115. Typically, the registration occurs after the initial activation of the gateway 120. After completing the registration, a token is granted to the gateway 120, and thereafter, the gateway 120 can upload data to the server 115 through a secure link (not shown). All bridges 130 propagate their uplink data to the server 115 through the gateway 120. It should be noted that IoT tags 140 cannot directly send data to the gateway 120, as their data packets are relayed through at least one bridge 130.

In some embodiments, the gateway 120 is configured to communicate its capabilities to the server 115. Such capabilities may include, but are not limited to, a type of uplink protocol (e.g., HTTP), a downlink capability (gateway 120 can propagate configuration commands or data to bridges 130), a downlink protocol, ability to update other bridges 130 (including firmware updates), and so on.

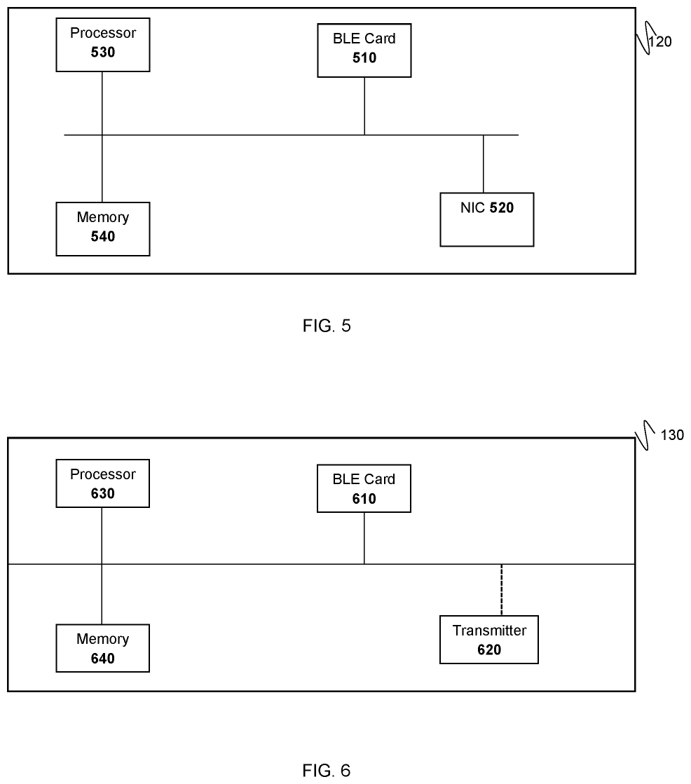

In some embodiments, the gateway 120 is implemented as a physical device, discussed in detail below with reference to FIG. 5. Alternatively, in some embodiments, the gateway 120 may be realized as a virtual device (e.g., a software container, a virtual machine, etc.) executed over a physical device including a network interface for communication over the networks 150 and 160.

A bridge 130 is configured to communicate with one or more IoT tags 140. In an embodiment, a bridge 130 is configured to receive data packets from IoT tags 140 and relay them to the gateway 120. In an embodiment, such data packets are encapsulated in BLE advertising packets. A BLE advertising packet is a small broadcast message sent by a BLE device to advertise its presence to other devices in the vicinity. The advertising packet typically contains information such as the device's name, unique identifier (UUID), services offered, and other relevant data.

BLE advertising packets are used for proximity-based services and applications, such as beacon technology, location tracking, and device pairing. They are designed to be energy-efficient, allowing devices to conserve battery power while still transmitting information to other devices. BLE advertising packets have a limited size, typically ranging from 31 to 255 bytes, depending on the type of packet and the Bluetooth specification version being used. The packet structure is defined by the Bluetooth SIG (Special Interest Group) and consists of different fields that contain the advertising data and metadata, such as the length of the packet and the type of packet.

A bridge 130 may be managed by the server 115 through commands sent through the gateway 120. In an embodiment, a single bridge 130 represents a single point of management for all its functions. That is, the server 115 may use the same destination address to configure all the functions contained within a single bridge 130. In an example configuration, an address of a bridge 130 is its unique identifier.

In an embodiment, the bridge 130 is configured to implement control network stack functions for controlling the IoT tags 140. The functions may include the discovery of IoT tags 140, energizing of IoT tags 140, calibration of IoT tags 140, and power management of IoT tags 140. Other control network stack functions can be added to a bridge 130. In an embodiment, the energizing of IoT tags 140 includes transmitting constant wave (CW) signals at frequency bands of 2.4 GHz and 1 GHZ.

In some embodiments, a bridge 130 is implemented as a physical device, discussed in detail below with reference to FIG. 6. Alternatively, in some embodiments, the bridge 130 may be realized as a virtual device (e.g., a software container, a virtual machine, etc.) executed on a physical device including a network interface for communication over the network 160 and energizing module for energizing the IoT tags 140. In such embodiments, a number of bridges 130 can be integrated into a single physical device where each bridge 130 is identified by its own unique ID. In certain embodiments, the gateway 120 and one or more bridges 130 can be implemented or integrated on a single physical device.

It should be noted that although one gateway 120 and one server 115 are depicted in FIG. 1 merely for the sake of simplicity, the embodiments disclosed herein can be applied to a plurality of gateways 120 and servers 115. The servers 115 may be part of one or more data centers, server frames, private cloud, public cloud, hybrid cloud, or combinations thereof.

The IoT network 100 may be arranged in a symmetric topology or an asymmetric topology. In the symmetric topology, a group of bridges 130 is associated with one or more gateways 120, such that there is a symmetric connection between a gateway 120 and a bridge 130. The association or mapping between a bridge and a gateway may be established through a discovery process. In the symmetric topology, downlink messages sent from the cloud computing platform to a specific bridge 130, are broadcasted to all gateways 120 to which the specific bridge 130 is connected. Further, uplink messages are sent by a bridge 130 to a gateway(s) 120 associated with that bridge.

In the asymmetric topology, an asymmetric connection is established between a gateway 120 and a bridge 130. Here, a bridge 130 can send uplink messages to a gateway 120, but a downlink communication from a gateway 120 to a bridge 130 cannot be guaranteed. The topology between gateways 120 to bridges 130, when an asymmetric connection is applied, may be in the form of a tree or acyclic graph. As such, bridges 130 are unaware of which gateway 120 routes a downlink message. However, in the uplink direction, the server 115 has the information from the uplink route, i.e., via which route the message was sent from a specific bridge 130 through a specific gateway 120. A discovery protocol, different from the symmetric topology discovery protocol, is being utilized to discover the bridges 130 in the IoT network 100.

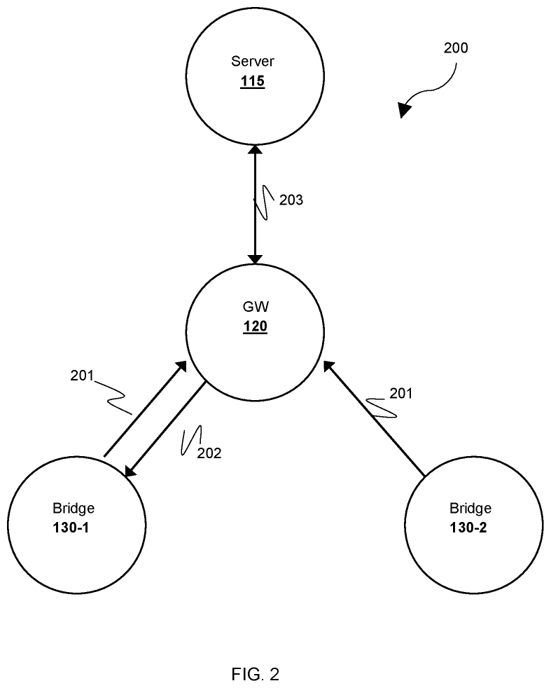

FIG. 2 shows an illustrative diagram of an asymmetric topology 200 of the IoT network according to an embodiment. FIG. 2 is discussed with reference to the elements shown in FIG. 1, where only 2 bridges are shown. As demonstrated, the topology 200 is a graph (tree) where the root is a server 115 in the cloud computing platform 110, the leaf of the topology 200 are bridges 130-1 and 130-2, and the intermediate node is gateway 120. In the example shown in FIG. 2, there is only one gateway 120, but a plurality of gateways are also applicable.

The asymmetric topology 200 can be represented as a directed acyclic weighted graph where edges between a gateway 120 and bridges 130 may include an uplink edge 201 and a downlink edge 202. Note that there is always an uplink edge 201, but there may not be a downlink edge 202 between a gateway 120 and bridges 130, as this is an asymmetric topology. In the example shown in FIG. 2, there is no downlink edge between the gateway 120 and the bridge 130-2. That is, a downlink edge exists between a gateway 120 and a bridge 130, when the bridges 130 can receive downlink messages from the gateway 120. The weight of an edge on the graph (tree) represents the reliability of the connection. In an example embodiment, the reliability is presented as a received signal strength indication (RSSI).

For an uplink edge 201, the RSSI is measured by a gateway 120 based on uplink packets transmitted by a bridge 130. For example, the uplink edge 201 between gateway 120 and a bridge 130-1 is the RSSI measured by gateway 120 for uplink packets transmitted by a bridge 130-1. It should be noted that the topology 200 is constantly updated with every uplink packet being received by a gateway. For a downlink edge 202, the RSSI is measured by a bridge 130 based on downlink packets (or signals) transmitted by a gateway 120 and received at the bridge 130. For example, the downlink edge 202 between the gateway 120 and a bridge 130-1 is the RSSI measured by a bridge 130-1 for downlink packets transmitted by the gateway 120.

In an embodiment, the edge 203 between the gateway 120 and the server 115 is a bi-directional communication link considered to be solid. This is because the connection between the gateway 120 and server 115 is over the Internet.

A graph of the asymmetric topology 200 can be maintained by each gateway 120 and/or the server 115. The server 115 may query the graph to determine a route to reach a bridge when a downlink message should be sent. A downlink message is typically sent when a bridge has to be updated. For example, updating a firmware of a bridge is made through a downlink message sent by the server 115. A method for describing the process of updating a bridge is discussed below.

In some embodiments, network events are generated in response to changes in the topology of the IoT network 100 (regardless of its topology). The network events may be reported to a user managing the IoT network. The network events may include a gateway event being triggered when a connection between a server 115 and a gateway 120 is disconnected. A network event may also include a tag event when a bridge 130 losses all its uplink connections. The detection and reporting of such network events may be performed by the server 115.

As noted above, in an embodiment, a bridge 130 is configured to send and receive BLE advertising packets to the gateway 120. Such data packets may be related to the operation and configuration of the bridge 130 or data sent by the IoT tags 140. To distinguish between the source of data, a different Service-UUID value is designated in the BLE advertising packets.

Each bridge 130 is periodically configured to transmit BLE advertising packets to the gateway 120. Such packets are relayed to the server 115, which is configured to maintain and monitor the state of each bridge 130. The state of bridge 130 may be advertised based on a configurable policy. A policy may define, for example, a length of burst for each advertisement message (number of retransmissions), the interval between messages within a burst, a period of time between bursts of different bridges, and a whole cycle length (the period between bursts of the same bridge). In some embodiments, a default policy may be pre-configured.

In an embodiment, a bridge 130 is configured to transmit and receive advertisement packets of different types (the structure of a packet is the same). Such packets include a state-type packet, a power mode packet, an operation mode packet, and a calibration packet.

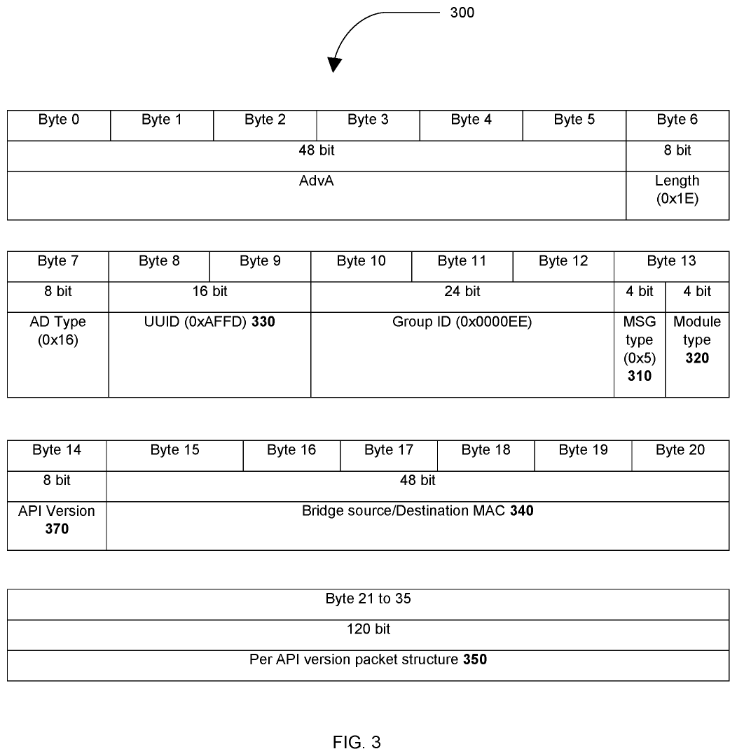

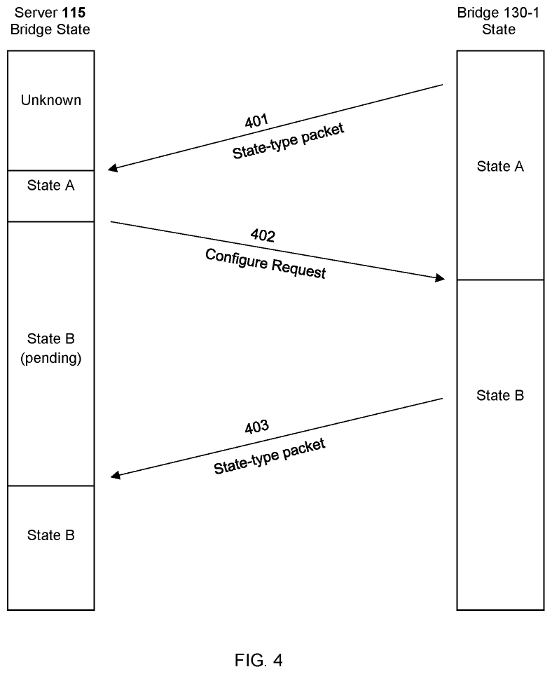

FIG. 3 shows an example structure 300 of a BLE advertising packet transmitted by a bridge 130 according to an embodiment. The packet type and the mode are designated in fields 310 and 320. The source of the packet is designated in the UUID field 330. The state-type packet includes configuration information related to the bridge indicated in filed 340. The configuration information includes at least a firmware version, an application programming interface (API) version 370, and a list of capabilities the bridge supports. It should be noted that the state-type packet may be utilized to update the capabilities of a bridge 130. An example flow to update the bridge's configuration is shown in FIG. 4.

The power mode packet is sent by gateway 120 (in response to a command by server 115) to energize the IoT tags 140 in a specific frequency band (e.g., 1 GHz or 2.4 GHZ). An operation mode packet defines the datapath for packets received by a bridge. The datapath defines if packets from IoT tags 140 are aggregated by the bridge or immediately sent to a gateway upon reception. The calibration packet carries a calibration frequency or a reference signal sent to IoT tags 140.

In an embodiment, the server 115 is configured to receive the state-type BLE advertising packets (including the configuration information), parse such packets, and update the state of a bridge in a database (not shown) maintained by server 115. The state of each bridge is updated upon reception of the state-type BLE advertising packet. The parsing of the packet is performed based on the API version. The API version describes the configuration and advertisement packets' structure for the bridge. The maintained state for each bridge includes at least a firmware version, an API version, a power mode, and a datapath of the bridge. The server 115 also records the unique address of the bridge. In an embodiment, the state information of a bridge may be maintained on the graph showing the IoT network topology.

According to the disclosed embodiments, the server 115, from time to time, is required to configure the bridges 130 to update their firmware, API version, power mode, or operation mode. The instructions to server 115 on the required configuration of the bridges 130 may be received from a user through a portal (not shown).

As noted above, the communication with the bridges 130 is through a portion of the BLE protocol that uses BLE advertising packets. However, such a portion of the protocol is unreliable as it is not designed to support ACK/NACK handshake of messages. To this end, in order to ensure that instructions for configuration are implemented by the bridges and confirmation for such is received by the server 115, a bridge configuration flow is realized according to the disclosed embodiments.

FIG. 4 shows an example flow diagram illustrating the bridge configuration flow according to an embodiment. The bridge typically has multiple configurable options that together form a state. In the example FIG. 4, the configuration of a bridge 130-1 by the server 115 is performed.

Initially, the state (“State A”) of the bridge 130-1 is not registered with the server 115. A state-type BLE advertising packet 401 designating the state of bridge 130-1 is received at the server 115. As noted above, such packets are periodically sent by the bridges and received by the server 115. The state-type BLE advertising packet includes a firmware version, an API version, and a list of capabilities supported by the bridge.

The state-type BLE advertising packet 401 is received at the server 115 and the state of the bridge 130-1 is updated accordingly. As noted above, the server 115 is configured to parse such packets and extract the relevant information to record the state.

Upon receiving instructions to update the state of the bridge to a new state (“State B”), a configure request 402 is sent to the bridge 130-1. Such a request is encapsulated in BLE advertising packet and relayed through the gateway 120. In an embodiment, the configure request 402 is structured based on a new API version that describes the configuration and advertisement packets' structure for the bridge 130-1. The new API version is requested by a user.

In an embodiment, prior to sending the configure request 402, the state of the bridge 130-1 at the server 115 is updated to pending, e.g., “State B Pending.” Further, before sending a configure request 402, the server 115 is configured to query the network topology for an existing reliable path to the target bridge (e.g., a bridge 130-1). When a reliable path does not exist, the server 115 is configured to wait for the bridge 130-1 to reconnect and re-query the network topology path. When the reliable path exists, the server 115 is configured to send the configuration to the gateway 120 with downlink abilities that have a connection to the target bridge 130-1.

In an embodiment, after sending the configure request 402, the server 115 is configured to wait for a predefined time window to receive a completion message. Such a message is a state-type BLE advertising packet the bridge 130-1 designating the current configuration. If the completion message is received by the server, the server sets the current state of the bridge to the desired state. In some embodiments, if the completion has not arrived within the predefined time window, the server 115 may re-query the network topology for a reliable path and re-attempt transmission of the configure request 402. In some embodiments, after a predefined number of unsuccessful attempts, the server 115 reports a failure to configure the bridge 130-1 and clear the pending state. API and Ul are updated accordingly.

When the state-type BLE advertising packet 403 is received at the server 115, the server 115 is configured to parse the bridge's state 130-1 at its database. It should be noted that such a database may include a file, such as a JSON file stored at the server 115.

In some embodiments, a bridge 130 may be configured via side band (i.e., not through a configure request 402 sent by the server 115. In such embodiments, the server 115 is configured to synchronize on the new state of the bridge through the periodic state-type BLE advertising packets sent by the bridge.

In some embodiments, the server 115 may determine that a state of a bridge is different than the state maintained or registered at the server. In such embodiment, the registered states may be updated with the state included in the received state-type BLE advertising packet. It should be noted that the server 115 does not initiate any reconfiguration of the bridge when a difference in configuration is detected.

FIG. 5 shows an example of a diagram of a gateway 120 constructed according to an embodiment. The gateway 120 may include a BLE communication card 510 and a network interface card (NIC) 520, the BLE communication card 510 communicates with the bridges 130 over a BLE network (e.g., 160, FIG. 1), while the NIC 520 allows communication with the server 115 over the Internet or other type of network. It should be noted that the BLE communication card 510 may support any type of a low-power communication protocol.

In an embodiment, the gateway 120 also includes a processor 530 and a memory 540. The processor 530 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 540 may be volatile (e.g., RAM, etc.), non-volatile (e.g., ROM, flash memory, etc.), or a combination thereof. The agent (or application) are realized in software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processor 530, cause the execution of the gateway operations as described herein.

FIG. 6 shows an example block diagram of a bridge 130 constructed according to an embodiment. The gateway 120 may include a BLE communication card 610 to communicate with the gateway 120 and IoT tags 140 over a BLE network (e.g., 160, FIG. 1). It should be noted that the BLE communication card 610 may support other types of low power communication protocols. The bridge 130 also includes a low-power RF transmitter 620 to transmit CW signals to energize the IoT tags 140. The RF transmitter 620 transmits CW signals at different frequency bands, such as 2.4 GHZ and 1 GHz. The transmitter 620 is controlled by the processor 630.

In an embodiment, the bridge 130 also includes a processor 630 and a memory 640. The processor 630 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 640 may be volatile (e.g., RAM, etc.), non-volatile (e.g., ROM, flash memory, etc.), or any combination thereof. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processor 630, cause the execution of the bridge operations as described herein.

The embodiments disclosed herein can be implemented as hardware, firmware, software, or any combination thereof. The application program may be uploaded to, and executed by, a machine comprising any suitable architecture. Preferably, the machine is implemented on a computer platform having hardware such as one or more central processing units (“CPUs”), a memory, and input/output interfaces.

The computer platform may also include an operating system and microinstruction code. The various processes and functions described herein may be either part of the microinstruction code or part of the application program or any combination thereof, which may be executed by a CPU, whether or not such computer or processor is explicitly shown.

In addition, various other peripheral units may be connected to the computer platform such as an additional network fabric, a storage unit, and the like. Furthermore, a non-transitory computer-readable medium is any computer-readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

What is claimed is:

1. A method for updating a configuration of a bridge in a network comprising at least the bridge, a gateway, and a server, the server being communicatively coupled to the gateway which is in turn wirelessly communicatively coupled to the bridge, the bridge being for communicating with and supplying energy for operation to Internet of Things (IoT) wireless tags, the updating being performed using at least a portion of a protocol for wireless communication between the gateway and the bridge that does not support acknowledgement (ACK) messages or no acknowledgement (NACK) messages, the method comprising:
receiving by the server an indication of a current state of the bridge;
when the current state of the bridge is not a desired state:
setting, in the server, the current state of the bridge to pending for the desired state;
transmitting, by the server toward the bridge, a configure request to update the bridge to the desired state; and
when, within a predetermined period of time of transmitting the configure request, a completion message is received by the server from the bridge in response to updating the bridge configuration in response to the configure request, setting the current state of the bridge to the desired state in the server.

2. The method of claim 1, wherein the portion of the protocol for wireless communication comprises only Bluetooth low energy (BLE) advertising packets.

3. The method of claim 1, further comprising:
waiting, by the server, for the predetermined period of time after transmitting the configure request to receive a completion message from the bridge; and
when the predetermined period expires without receipt of the completion message, transmitting again by the server toward the bridge the configure request to update the bridge to the desired state.

4. The method of claim 1, further comprising:
querying the network for an existing reliable path to the bridge wherein, transmitting the configure request is performed only when there is a reliable existing path to the bridge; and
when a reliable existing path to the bridge does not exist, waiting a prescribed period for a reliable path to become available.

5. The method of claim 4, wherein waiting for a reliable path to the bridge to become available is to allow the bridge to reconnect, wherein the method further comprises:
again querying the network for an existing reliable path to the bridge upon expiration of the prescribed period.

6. The method of claim 1, wherein the indication of the current state of the bridge includes at least one of a firmware version, an application programming interface (API) version, and a list of at least one capability of the bridge.

7. The method of claim 1, wherein the configure request is structured based on a new application programming interface (API) version that describes the updated configuration and a new advertisement packets' structure.

8. The method of claim 7 wherein the new API version was requested by a user.

9. The method of claim 1, wherein the configure request is transmitted from the server to the gateway and thereafter is relayed by the gateway to the bridge.

10. The method of claim 1, wherein the current state of the bridge is received at the server by being relayed thereto from the gateway.

11. The method of claim 1 wherein the current state of the bridge, the configure request, and the completion message are each in a Bluetooth low energy (BLE) advertising packet.

12. The method of claim 11 wherein the current state of the bridge, the configure request, and the completion message are each a state-type BLE advertising packet.

13. A method for updating a configuration of a bridge in a network comprising at least the bridge, a gateway, and a server, the server being communicatively coupled to the gateway which is in turn wirelessly communicatively coupled to the bridge, the bridge being for communicating with and supplying energy for operation to Internet of Things (IoT) wireless tags, the updating being performed using at least a portion of a protocol for wireless communication between the gateway and the bridge that does not support acknowledgement (ACK) messages or no acknowledgement (NACK) messages, the method comprising:
transmitting by the bridge an indication of a current state of the bridge toward the server;
receiving, by the bridge, a configure request to update the bridge to a desired state; and
transmitting, by the bridge, a completion message toward the server in response to the bridge successfully completing the updating of the bridges configuration per the configure request.

14. The method of claim 13, wherein the portion of the protocol for wireless communication comprises only Bluetooth low energy (BLE) advertising packets.

15. The method of claim 13, wherein the indication of the current state of the bridge includes at least one of a firmware version, an application programming interface (API) version, and a list of at least one capability of the bridge.

16. The method of claim 13, wherein the configure request is structured based on a new application programming interface (API) version that describes the updated configuration and a new advertisement packets' structure.

17. The method of claim 16 wherein the new API version was requested by a user.

18. The method of claim 13, wherein the configure request is received from the server as relayed by the gateway to the bridge.

19. The method of claim 13, wherein the current state of the bridge is transmitted toward the gateway to be relayed thereby to the server.

20. The method of claim 13 wherein the current state of the bridge, the configure request, and the completion message are each in a Bluetooth low energy (BLE) advertising packet.
